(19) United States
(12) Patent Application Publication
(10) Pub. No.: US 2014/0048205 A1
(43) Pub. Date: Feb. 20, 2014

(54) Method of Manufacturing a Seal of a Vacuum Bag for an Infusion Molding Process

(71) Applicant: Salvador Chava Balas, Jupiter, FL (US)

(72) Inventor: Salvador Chava Balas, Jupiter, FL (US)

(21) Appl. No.: 13/889,571

(22) Filed: May 8, 2013

Related U.S. Application Data
(60) Provisional application No. 61/683,982, filed on Aug. 16, 2012.
(60) Provisional application No. 61/794,388, filed on Mar. 15, 2013.

(51) Int. Cl. B29C 37/00

(52) U.S. Cl. CPC B29C 37/0089
USPC 156/285

(57) ABSTRACT

A method is disclosed for forming a seal on a vacuum bag used in an infusion molding process. A seal profile having a first part and a second part is attached to a supporting surface and resin is applied to the seal profile to form a mold layer. The mold layer and the seal profile are separated from the supporting surface. The second part of the seal profile is separated from the first part of the seal profile. A silicone resin is applied to the mold layer and the first part of the seal profile to form the seal and the vacuum bag. A vacuum cavity is created between the mold layer and the second resin when the second resin is applied to the first part of the seal profile.

### CROSS-REFERENCE TO RELATED APPLICATIONS

This application the benefit of U.S. provisional Application No. 61/683,982 filed Aug. 16, 2012 and U.S. provisional Application No. 61/794,388 filed Mar. 15, 2013, the disclosures of which are incorporated in their entirety by reference herein.

### TECHNICAL FIELD

This application relates to a method of manufacturing an edge seal for a vacuum bag for an infusion molding process.

### BACKGROUND

Vacuum bag molding is a process that uses a flexible film to enclose a part. A vacuum is drawn on the vacuum bag on one side of the part and atmospheric pressure compresses the part from the other side during a curing step. Vacuum bags used in vacuum bag molding processes may be provided in either a tube shape or sheet form.

Seals at the edges of the vacuum bag form a seal against the edges of the mold surface to enclose the part in an air-tight mold. The lower mold is a rigid structure and the upper surface of the part is formed by the vacuum bag that forms a flexible membrane. The body of the vacuum bag may be a reusable silicone material or an extruded polymer film. A vacuum is drawn on the part and held while the part is cured.

The vacuum bag is a bag made of strong elastomer coated fabric or a polymer film of sufficient thickness to compress the part during a curing or hardening step. Vacuum is applied to the parts during curing on one side with a uniform pressure of approximately one atmosphere being applied to the parts through the vacuum bag.

Vacuum bagging is widely used in the composites industry. Carbon fiber fabric and fiberglass fabric may be infused with resins or epoxies in a vacuum bagging operation. Infusion molding is used to transfer resin from one area of a part being manufactured to another area. Infusion molding also may be used to consolidate laminated layers by removing entrapped air. The vacuum bag, as previously described, may be used to form a vacuum chamber in combination with a mold. Atmospheric pressure applied to the vacuum bag compresses the laminated composite part as the resin cures.

Several processes may be used to manufacture a bag suitable for use in an infusion molding operation. A reusable polymer bag may be manufactured by spraying, swirl spraying, SWORL™ spraying, or brush application of one or more layers of a polymeric material over the mold.

One problem encountered in manufacturing parts using an infusion molding process is that the vacuum bag may conform to the part to an extent that drawing a vacuum becomes difficult. Another problem is that air may become entrapped between a reusable vacuum bag and the part that reduces the pressure on the part. Resin movement may be blocked in areas where the bag impinges upon the mold. Some of the resin may flow non-uniformly and may reach the mold edge before resin in other portions of the mold reach the mold edge. Non-uniform resin flow may block the narrow passages located between the mold edge and the bag.

The vacuum molding bag is typically placed on a plug flange with double sided tape. Several people may be required to attach the vacuum bag to the plug flange in a large mold or the seal may become dislodged from the plug flange.

This disclosure is directed to solving one or more of the above problems and other problems as summarized below.

### SUMMARY

According to one aspect of this disclosure, a method is provided for forming a seal on a vacuum bag used in an infusion molding process. The method comprises securing a seal profile having a first part and a second part to a supporting surface. A first resin is applied to the seal profile to form a mold layer on the supporting surface. The mold layer and the seal profile are removed from the supporting surface. The second part of the seal profile is separated from the first part of the seal profile. A second resin is applied to the mold layer and the first part of the seal profile to form the seal on the vacuum bag.

According to other aspects of the disclosed method, the first part of the seal profile may be secured to the second part of the seal profile with a key and keyway connector. The supporting surface may be part of a plug flange and the step of securing the seal profile to the supporting surface may be performed by inserting a segment of double face tape between the seal profile and the plug flange.

The method may further include the step of inverting the mold layer after separating the mold layer and the seal profile from the supporting surface to expose a surface of the mold layer and the first part of the seal profile before applying the second resin. A cavity may be created between the mold layer and the second resin by applying the second resin to the first part of the seal profile. The first part of the seal profile may be secured to the second part of the seal profile with an adhesive.

According to another aspect of this disclosure, a method of forming a vacuum bag for use in an infusion molding process is disclosed that uses a plug flange that defines a flange and a seal profile in the form of a cavity. The method comprises the steps of inserting a filler into the cavity in a bottom portion of the cavity, and applying a resin over the plug flange, flange seal profile, and filler to form a seal on the vacuum bag.

Other aspects of this disclosure relate to the method of forming a vacuum bag for use in an infusion molding process. The method may further comprise curing the resin, and removing the seal and the vacuum bag from the plug flange. The method of forming a vacuum bag for use in an infusion molding process may further comprise utilizing the vacuum bag for forming a part in a mold in combination with the plug flange. The method of forming a part includes the further steps of removing the filler from the bottom portion of the cavity and inserting the seal in the cavity with the bottom portion of the cavity defining a vacuum cavity. Next, the vacuum bag may be placed over the mold with a vacuum being drawn in the vacuum cavity to hold the seal in the cavity. The vacuum is also drawn between the mold and the vacuum bag while infusing a reinforcement fiber disposed between the mold and vacuum bag with a second resin.

The resin forming the seal and the vacuum bag may be a silicone resin, and the method of forming a part may further comprise reusing the vacuum bag by repeating the steps of inserting the seal in the cavity with the bottom portion of the cavity defining a vacuum gap. The vacuum bag is then placed over the mold. A vacuum may be drawn in the vacuum cavity to hold the seal in the cavity. Vacuum is drawn between the mold and the vacuum bag while infusing a reinforcement fiber disposed between the mold and vacuum bag with a second resin.

According to another aspect of this disclosure, a method is disclosed for forming a vacuum bag and a seal on the vacuum bag for use in an infusion molding process. The method may comprise providing a seal profile on a supporting surface, assembling a seal profile filler to a bottom portion of the seal profile, and applying a resin to the seal profile, the seal profile filler, and the supporting surface to form the vacuum bag and a seal on the vacuum bag.

The above aspects and other aspects of this disclosure will be described in greater detail below with reference to the attached drawings.

### BRIEF DESCRIPTION OF THE DRAWINGS

FIG. 1 is a schematic isometric view showing one embodiment of an infusion molding system;

FIGS. 2A-J schematically illustrate one example of a method of manufacturing a vacuum bag with a two-part seal profile assembly that may be used to form a vacuum gap;

FIG. 3 is cross-sectional view of a one-piece seal profile;

FIG. 4 is a fragmentary cross-section through an isometric view of an existing flange seal and a seal profile disposed above the flange seal;

FIGS. 5A-D are cross-sectional view of two-part flange seals having several different shapes;

FIG. 6 is a fragmentary cross-sectional view of a new mold seal; and

FIGS. 7A-B illustrate one example of a method of using a two-part vacuum bag seal.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts. References to chemical compositions and materials are to the presently preferred compositions and it should be understood that other materials and compositions may be used.

Except in the examples, or where otherwise expressly indicated, numerical quantities used to indicate dimensions are to be understood as being modified by the word “about” when describing the broadest scope of the concept disclosed. Unless expressly stated to the contrary, the term “polymer” includes “oligomers,” “copolymer,” “terpolymer,” “pre-polymer,” and the like.

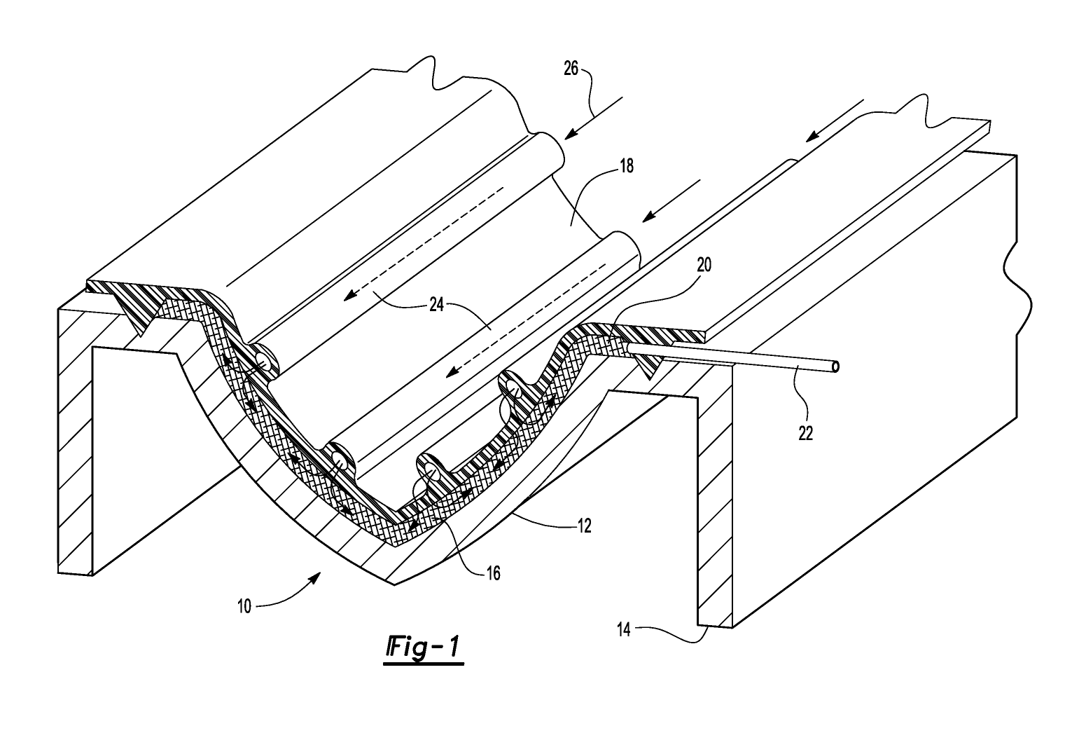

Referring to FIG. 1, one embodiment of a infusion molding system 10 is schematically illustrated. The infusion molding system 10 may be suitable for use in the manufacture of marine parts and also may be used in non-marine applications. Non-marine applications may include automotive, aerospace, or other industrial applications that use molds to form parts.

The infusion molding system 10 may be used in conjunction with an oven or an autoclave. The infusion molding system 10 may be used within a temperature range of from 32° F. to 600° F. More specifically, the infusion molding system 10 may be used in a temperature range of 70° F. to 450° F.

In the infusion molding system 10 shown in FIG. 1, a mold 12 is disposed on a mold base 14. A reinforcement 16 comprising, for example, fiberglass, carbon fibers, or the like, may be placed on the mold 12 and generally conformed to the shape of the mold 12. A vacuum bag 18 having a shape corresponding to the shape of the mold 12 is overlaid over the reinforcement 16. The vacuum bag 18 and mold 12 define a space that encloses the entire reinforcement 16.

The vacuum bag 18 and mold 12 define a cavity 20 that encloses the reinforcement 16. A vacuum tube 22 is provided to draw a vacuum in the cavity 20 and is connected to a vacuum source (not shown). It should be understood that the mold 12 may be rigid, semi-rigid, or pliable. At least one resin supply tube 24 is disposed adjacent to the vacuum bag 18 and is supplied with resin 26 that flows from a resin supply source (not shown). The resin 26 flows into the space between the vacuum bag 18 and mold 12 that contains the reinforcement 16. The resin 26 is infused into the reinforcement 16 as it flows through the cavity 20. A portion of the resin 26 may flow into the cavity 20.

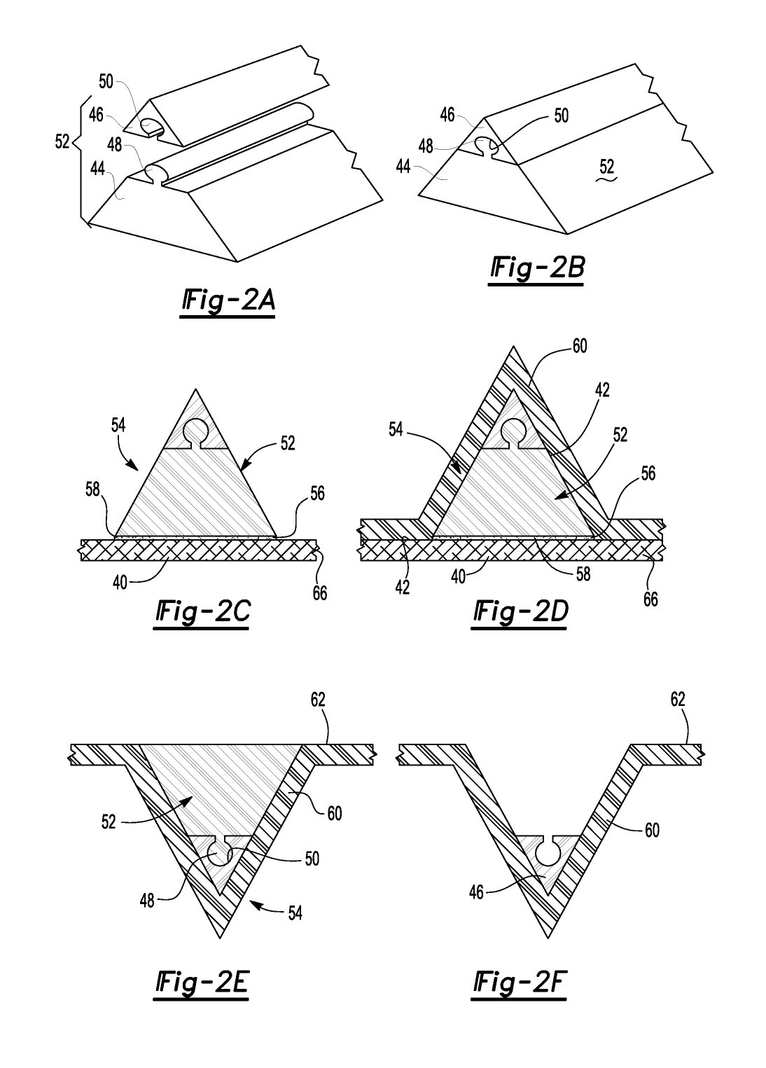

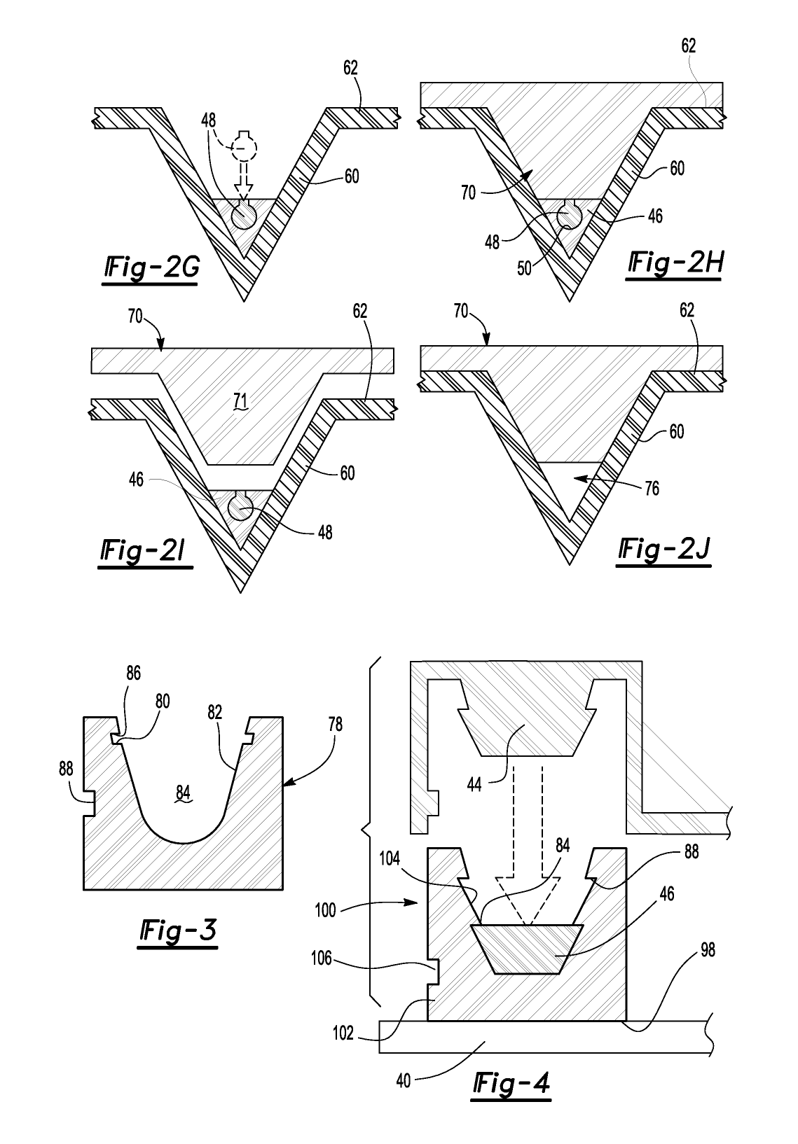

FIGS. 2A-J schematically illustrate one example of a method of manufacturing a seal ring on a vacuum bag 18.

Referring to FIG. 2A, a first seal profile portion 44 and a second seal profile portion 46 are shown separated from each other. The first seal profile portion 44 includes a key 48 that is received in a keyway 50 defined by the second seal profile portion 46.

Referring to FIG. 2B, a seal profile assembly 52 is illustrated that is formed by assembling the first seal profile portion 44 to the second seal profile portion 46 with the key 48 being received in the keyway 50 to interlock the first and second seal profile portions 44 and 46 together.

Referring to FIG. 2C, a supporting surface, or a plug flange 40, and seal profile assembly 52 are generally indicated by reference numeral 54. The seal profile assembly 52 is removably secured to the plug flange 40. The seal profile assembly 52, in at least one embodiment, may be detachably secured using a double-sided tape 58. An edge 56 of the seal profile 52 that is closest to a plug flange edge 66 may be disposed from 0.1 inches to 4 inches from the plug flange edge 66. More specifically, the edge 56 of the seal profile assembly 52 may be disposed within 0.5 inches to 1.5 inches from the plug flange edge 66.

The plug flange 40 may include a part surface made of a polyester composition, a vinyl ester composition, an epoxy composition, phenolic composition, a metal composition, and/or a ceramic composition. The plug flange 40 may include a part surface that is reproduced by splashing the part.

Referring to FIG. 2D, a mold layer 60 is shown applied to and covering the flange-seal profile assembly 54. The mold layer 60, in one embodiment, includes a tooling gel formed of a polyester composition. The polyester composition may have a Barcol hardness ranging between 40-55 when measured with a 40 gram weight at 25° C. according to ASTM D-2583. Alternatively, the mold layer 60 may include a thermoset composition or a thermoplastic composition. Plug flange 40 and flange-seal profile assembly 54 define a mold surface 42.

Referring to FIG. 2E, the flange-seal profile assembly 54 is illustrated after plug flange 40 is removed and the profile assembly 54 is inverted as compared to FIG. 2D. The mold layer 60 is oriented so that the seal profile assembly 52 and mold layer surface 62 may receive a spray-on, swirl-spray-on, SWORL™-spray-on, or brush-on layer.

Referring to FIG. 2F, the mold layer 60 is shown with the second seal profile portion 46 lodged inside the mold layer 60. The first seal profile portion 44 (shown in FIG. 2E) is removed including its key 48 (also shown in FIG. 2E).

Referring to FIG. 2G, key 48 is shown in phantom line that may be removed from the first seal profile portion 44 or may be independently formed and is positioned above the keyway 50. The key 48 shown in solid line is reinserted into the keyway 50. Alternatively, keyway 50 may be closed or covered over by tape to prevent resin 26 or other material from entering the keyway 50 in subsequent steps.

Referring to FIG. 2H, a vacuum bag 70 is shown as it is applied to the mold layer surface 62 and second seal profile portion 46. The second seal profile portion 46 defines the keyway 50 that receives the key 48 that prevents the material forming the vacuum bag 70 from flowing into the keyway 50. The vacuum bag 70 may be sprayed-on, swirl-sprayed-on, SWORL™-sprayed-on, or brushed-on the mold layer surface 62. The vacuum bag 70 may be formed from a silicone resin or from a polyurethane resin, or a latex resin. For brevity, the resin is subsequently referred to as a silicone layer, or silicone bag 707, but it should be construed to include polyurethane resins, latex resins, and the like.

In one embodiment, the first layer of the silicone layer 70 may be sprayed onto the mold layer surface 62 and the second seal profile portion 46. A second layer of the silicone bag 70 may be brushed over the first layer of the silicone bag 70. The first layer of the silicone bag 70 is applied directly to the mold layer 62 and the second seal profile portion 46. Alternatively, the first layer of the silicone bag 70 may be brushed onto the mold layer surface 62 and the second seal profile portion 46 with a second layer of the silicone bag 70 being sprayed onto the brushed-on layer of the silicone bag 70 that is directly applied to the mold layer 62 and the second seal profile portion 46. In yet another embodiment, successive layers of the silicone bag 70 may be applied repeatedly without the need to wait for previous layers of the silicone bag 70 to be cured, be tack-free, or that are cured to any particular degree. The silicone bag 70 may also be made with a reinforcement, a mesh, a net, a filler material, a foaming agent, or a pigment.

Referring to FIG. 2I, the silicone bag 70 with an edge seal 71 is shown being removed from the surface layer 62. Subsequently, the second seal profile portion 46 may be removed from the mold layer 60.

Referring to FIG. 2J, the silicone bag 70 is shown reinserted into the mold layer 60 after the second seal profile portion 46 has been removed from the mold layer 60. The silicone bag 70 and mold layer portion 60 define a cavity 76 that may function as a vacuum gap. When a vacuum is drawn inside the cavity 76, atmospheric pressure holds the silicone bag 70 tight to the mold layer surface 62 and thereby forms an air-tight seal. The air-tight seal prevents air from entering the mold between the silicone bag 70 and the mold layer surface 62. Forming the bag 70 and seal 71 of silicone is advantageous because the silicone seal 71 formed on silicone bag 70 is reusable. Reusable seals expedite manufacturing and assure accurate and repeatable manufacture of the seals.

It should be understood that the description of forming a silicone bag 70 above comprises one embodiment and that other polymeric materials such as nylon or other thermoplastic compositions, may be applied to the mold layer surface 62 to form the silicone bag 70 and edge seal 71.

In an alternative embodiment to the embodiment described with reference to FIGS. 2A-J, the first seal profile portion 48 and second seal profile portion 46 may have a wax-based composition with sufficient tack to cause the profile portions 44, 46 to adhere together. In this embodiment, the key 48 and keyway 50 may be eliminated. Seal profiles having a wax composition may also include an adhesive layer between the first seal profile portion 44 and the second seal profile portion 46. First and second seal profile portions 44, 46 that are adhered together with an adhesive may be separated so that no adhesive remains on the second seal profile portion 46. In yet another embodiment, the first seal profile portion 44 may have a first adhesive layer adjacent to the second seal profile portion 46 and a second adhesive layer may be provided adjacent to the mold layer surface 62 when the seal profile assembly 52 is attached to the mold layer surface 60.

In an alternative embodiment, the first and second seal profiles 44, 46 may have a key 48 that is independent of the first seal profile portion 44. The key 48, if independent, need not be removed from the first seal portion 44. The key 48, if independent, is inserted in the keyway 50 as described with reference to FIG. 2G.

Assembly 52 may be used to make a new mold for the seal 71. Assembly 52 can also be used for making seals on existing plug flanges 40 using a one-piece seal shape 78 as shown FIG. 3. Alternatively, the seal shape may also be made with a plurality of pieces. Referring to the one piece seal shape 78, the seal includes walls 82 that define a cavity 84. A plurality of embossments 80 are formed by molding or machining a groove in the wall 82 to form a retention unit on the seal. The embossments 80 include an undercut 86 engendering a die lock or, at least, resistance to withdrawal of the seal 71 (shown in FIG. 2I.) Due to the flexible nature of the silicone bag 70, the seal 71 may be removed without damaging the silicone bag 70. The one piece shape 78 may also include an embossment 88 on an exterior surface of the one piece shape 78. While FIG. 3 shows an embossment, a similar function may also be afforded by providing a protrusion in place of the embossments 80, 88.

The width of the seal profile portion 44 may range from 0.25 inches to 4 inches. The height of the seal profile portion may have a height ranging from 0.50 inches to 3 inches.

The seal profile portions 44 and 46 and the silicone bag 70 may also be made from resins that have the same hardness. As an alternative, the Durometer ratings for the seal profile portions 44 and 46 and the silicone bag 70 may be different. In one embodiment, seal profile portions 44 and 46 adjacent to the undercut 86 may have lower Durometer ratings than the seal profile portions 44 and 46 and silicone bag 70 at locations spaced away from the undercut 86 to facilitate removing the seal profile portions 44 and 46 and bag from the one piece seal shape 78. The first seal profile portion 48 and second seal profile portion 46 may be formed of a composition having a Durometer ranging from 30 Shore A to 70 Shore B when measured according to ASTM B-2240.

Referring to FIG. 4, an existing flange (EF) seal 100 for an existing plug flange 40 is illustrated that may be used to make a vacuum bag that includes a seal. EF seals 100 are fastened directly to the plug flange 40 with an adhesive 98 and fasteners. The EF seal 100 includes a second seal profile portion 46 that may be assembled into an attachable seal portion 102. EF seal 100 may be used for forming a silicone bag 70. Attachable seal portion 102 includes an embossment 88. Embossment 88 and an outer bag channel lock 106 are provided on the attachable seal portion 102. A silicone bag 70, similar to the bag 70 shown in FIGS. 2I and 2J, may be applied directly over EF seal 100 with the second seal profile portion 46 being disposed in the bottom of the channel in the seal portion 102.

A bag wing lock 104 aligns the silicone bag 70 within the channel 84 to eliminate the need for an operator to identify locations where the bag 70 may not be mating correctly with the EF seal 100. If the bag is not properly aligned, outside air may be admitted into the vacuum gap 76 (shown in FIG. 2J) when the vacuum is initially pulled. The bag wing lock 104 reduces labor costs by allowing a single operator to seal the perimeter of the mold for any size mold without having to use clamps or weights that were traditionally used to hold the bag seal in place. Outer bag channel lock 106 functions to ensure vacuum integrity by increasing the surface area of the seal that grips the outside surface and by preventing the seal from opening if the bag seal seats too far into the channel 84.

The EF seal 100 allows replacement of messy wax and clay seals used on existing plug flanges and also reduces labor cost and processing cycle times. Replacing clay seals also eliminates the problem with prior art sulfur-based clay that may be used as a vacuum seal because there is no chemical incompatibility between the seals and the silicone bag 70.

The EF seal 100 may have a width of between 0.25 and 4 inches. The EF seal 100 may have a height ranging from 0.25 inches to 1.5 inches.

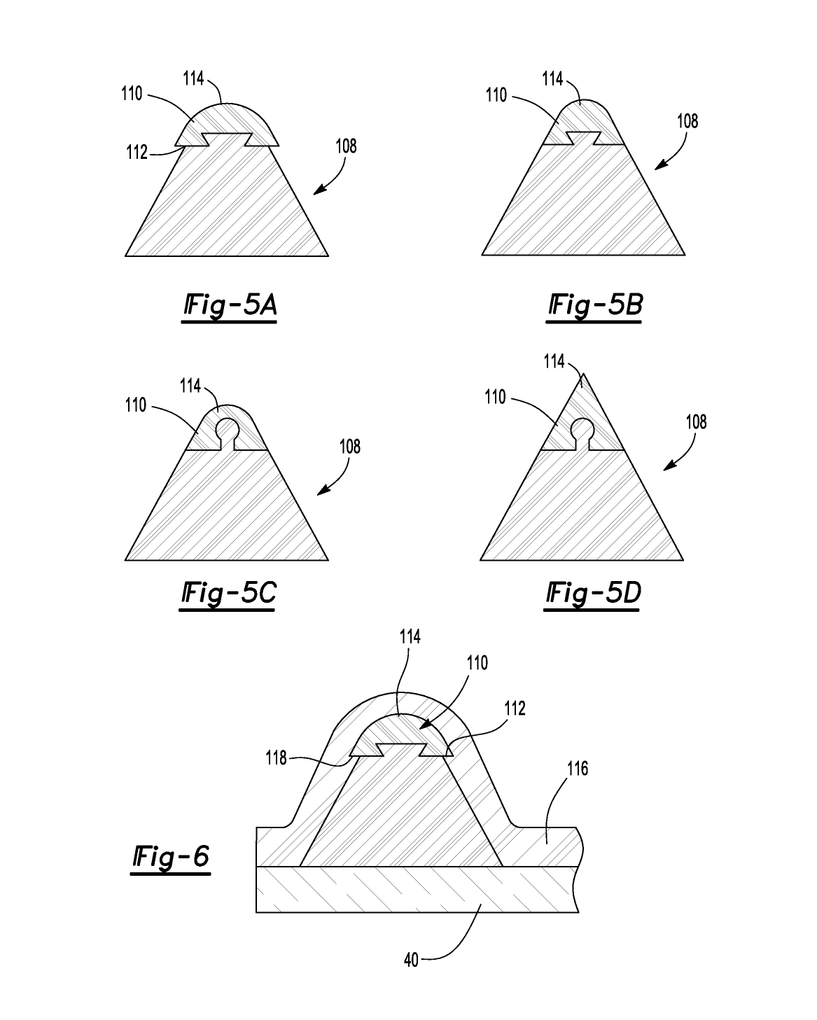

Referring to FIGS. 5A-D, several variations of a new mold (NM) first seal profile 108 are illustrated. The NM first seal profile 108 has a second seal profile portion 110 including a retention member 112 and an arcuate apex 114. Apex 114 may have a radius ranging from 0.25 inches to 8 inches. In another embodiment, apex 114 may have a radius ranging from 0.5 inches to 4 inches.

Referring to FIG. 6, the radius facilitates fabrication of a more durable mold flange wall 116 than if a sharp apex is provided. A sharp apex forms a stress riser in the mold flange wall 116 and may weaken the mold flange wall 166 that may tend to reduce the service life of the mold. Retention member 112 functions to retain the second seal profile portion 110 within the mold flange wall 116 after the mold flange wall 116 cures and before the silicone bag is applied. The second seal profile portion 110 may include a retention structure such as a keyway that may receive a key similar to the key 48 and keyway 50 described with reference to FIG. 2.

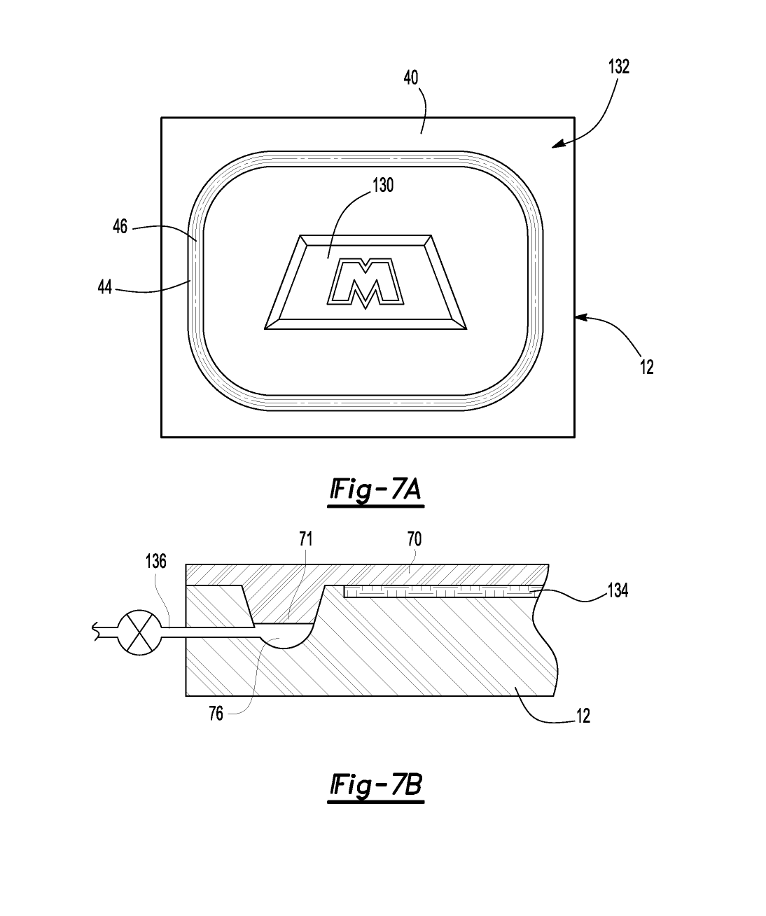

Referring to FIGS. 7A-B, a chrome plated name plate 130 may be temporarily secured and generally centered relative to a plug 132 having a plug flange 40. A frame (not shown) may be secured to the plug 132 about the periphery of the mold 12. The first seal profile portion 44 is secured to the plug flange 40. The second seal portion 46 is connected to the first seal profile portion 44 and is spaced from the plug flange 40. The mold 12 is formed by placing cooling gel and backing resin inside the frame on the plug 132, the plug flange 40, the first seal profile portion 44, and the second seal profile portion 46. The tooling gel and backing resin are applied to a depth exceeding the height of the first and second profile portions 44 and 46.

The mold 12 is removed from the plug 132 and first seal profile portion 44. The mold 12 is then inverted and the silicone bag 70 is applied to the mold 12 in the location where the second seal profile portion 46 is retained in the mold 12. If a keyway is provided, the keyway should be closed before the silicone bag 70 resin is applied to the mold 12 to prevent die lock.

Silicone bag 70 and second seal profile portion 46 are removed from the mold 12 after the silicone bag 70 is cured. The silicone bag 70 is returned to the mold 12 to define a resin cavity 134. At least one vacuum tube 136 is ported to the vacuum gap 76 that is formed by the seal 71 and the mold 12 (as shown in FIG. 2J). Referring to FIG. 1, a thermoset resin 26 is infused into the composite reinforcement 16, such as carbon fiber, fiberglass, or the like. The carbon fiber or fiberglass is infused with resin 26 received from a resin supply tube 24. Vacuum is drawn through the vacuum tube(s) 136 while the thermoset resin layer 134 cures.

To remove the silicone bag 70, vacuum and pressure is relieved through the vacuum tube 136. A molded part duplicating the chrome plated name plate 130 can then be removed from the mold. The cycle of applying vacuum and releasing vacuum may be repeated during the infusion and curing stages of the thermoset resin 26.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of forming a seal on a vacuum bag used in an infusion molding process, the method comprising:
securing a seal profile having a first part and a second part to a supporting surface;
applying a first resin to the seal profile to form a mold layer;
removing the mold layer and the seal profile from the supporting surface;
separating the second part of the seal profile from the first part of the seal profile; and
applying a second resin to the mold layer and the first part of the seal profile to form the seal on the vacuum bag.

2. The method of claim 1 wherein the first part of the seal profile is secured to the second part of the seal profile with a key and keyway connector.

3. The method of claim 1 wherein the supporting surface is part of a plug flange, and wherein the step of securing the seal profile to the supporting surface is performed by inserting a segment of double face tape between the seal profile and the plug flange.

4. The method of claim 1 further comprising the step of inverting the mold layer after separating the mold layer and the seal profile from the supporting surface to expose a surface of the mold layer and the first part of the seal profile for application of the second resin.

5. The method of claim 1 wherein during the step of applying the second resin the first part of the seal profile results in the creation of a cavity between the mold layer and the second resin.

6. The method of claim 1 wherein the first part of the seal profile is secured to the second part of the seal profile with an adhesive.

7. A method of forming a vacuum bag for use in an infusion molding process using a plug flange defining a flange seal profile as a cavity, the method comprising:
inserting a filler into the cavity in a bottom portion of the cavity; and
applying a resin over the plug flange, flange seal profile, and filler to form a seal on the vacuum bag.

8. The method of claim 7 further comprising:
curing the resin; and
removing the seal and the vacuum bag from the plug flange.

9. The method of claim 8 further comprising utilizing the vacuum bag to form a part in a mold in combination with the plug flange including the further steps of:
removing the filler from the bottom portion of the cavity;
inserting the seal in the cavity with the bottom portion of the cavity defining a vacuum cavity;
placing the vacuum bag over the mold;
drawing a vacuum in the vacuum cavity to hold the seal in the cavity and between the mold and the vacuum bag; and
infusing a reinforcement fiber disposed between the mold and vacuum bag with a second resin.

10. The method of claim 9 further comprising:
removing the vacuum bag from the mold; and
removing the part from the mold.

11. The method of claim 10 wherein the resin forming the seal and the vacuum bag is a silicone resin, and wherein the method of forming a part further comprises reusing the vacuum bag by repeating the steps of:
inserting the seal in the cavity with the bottom portion of the cavity defining a vacuum gap;
placing the vacuum bag over the mold;
drawing a vacuum in the vacuum cavity to hold the seal in the cavity and between the mold and the vacuum bag; and
infusing a reinforcement fiber disposed between the mold and vacuum bag with a second resin.

12. A method of forming a vacuum bag and a seal on the vacuum bag for use in an infusion molding process, the method comprising:
providing a seal profile on a supporting surface;
assembling a seal profile filler to a bottom portion of the seal profile; and
applying a resin to the seal profile, the seal profile filler, and the supporting surface to form the vacuum bag and a seal on the vacuum bag.

13. The method of claim 12 wherein during the step of applying the resin, the seal profile filler forms a vacuum cavity for the seal in the bottom portion of the seal profile.

14. A method of forming a part including the method of forming a vacuum bag of claim 12 and further comprising utilizing the vacuum bag to form a part in a mold in combination with the plug flange including the further steps of:
removing the filler from the bottom portion of the cavity;
inserting the seal in the cavity with the bottom portion of the cavity defining a vacuum cavity;
placing the vacuum bag over the mold;
drawing a vacuum in the vacuum cavity to hold the seal in the cavity and between the mold and the vacuum bag; and
infusing a reinforcement fiber disposed between the mold and vacuum bag with a second resin.

15. The method of claim 14 further comprising:
removing the vacuum bag from the mold; and
removing the part from the mold.

16. The method of claim 14 wherein the resin forming the seal and the vacuum bag is a silicone resin, and wherein the method of forming a part further comprises reusing the vacuum bag by repeating the steps of:
inserting the seal in the cavity with the bottom portion of the cavity defining a vacuum gap;
placing the vacuum bag over the mold;
drawing a vacuum in the vacuum cavity to hold the seal in the cavity and between the mold and the vacuum bag; and
infusing a reinforcement fiber disposed between the mold and vacuum bag with a second resin.
